(19) United States
(12) Patent Application Publication
(10) Pub. No.: US 2023/0339056 A1
(43) Pub. Date: Oct. 26, 2023

(54) MULTI-AXIS MACHINING CENTER PROVIDED WITH MECHANIZED TOOL MAGAZINE

(71) Applicant: VIGEL S.P.A., BORGARO TORINESE (IT)

(72) Inventors: Daniele FRANCESIA VILLA, MEZZENILE (IT); Diego STABIO, NOLE (IT)

(21) Appl. No.: 18/027,828

(22) PCT Filed: Sep. 21, 2021
(86) PCT No.: PCT/EP2021/075942

§ 371 Date: Mar. 22, 2023

(30) Foreign Application Priority Data
Sep. 24, 2020 (IT) 102020000022525

(51) Int. Cl. B23Q 3/157

(52) U.S. Cl. CPC B23Q 3/15722

(57) ABSTRACT

A machining center includes two independent carriages supported so that they can slide along respective longitudinal translation axes (X′, X″) by two parallel horizontal rails fixed in a raised position to a supporting structure. The carriages support respective machining heads which move along two respective translation axes (Y′, Y″, Z′, Z″). The machining heads support respective tool holding spindles arranged with a vertical axis. At least one workpiece holding table is supported at the base of the supporting structure in a rotatable manner about a first horizontal and transverse rotation axis (Yr′, Yr″) and about a second rotation axis (Hr′, Hr″) perpendicular to the first one. Two mechanized tool magazines are supported at the opposite longitudinal ends of the supporting structure and are accessible by the spindles.

### CROSS-REFERENCE TO RELATED APPLICATIONS

The present application is a 35 U.S.C. § 371 National Stage patent application of International patent application PCT/EP2021/075942, filed on 21 Sep. 2021, which claims priority to Italian patent application 102020000022525, filed on 24 Sep. 2020, the disclosures of which are incorporated herein by reference in their entirety.

### TECHNICAL FIELD

The present disclosure relates to a multi-axis machining center provided with mechanized tool magazine.

### BACKGROUND

As known, a multi-axis machining center may comprise generally a motorized tool holding spindle mounted on a machining head which can move along two or more axes, with respect to the workpiece to be machined, so as to subject the workpiece to different successive machining processes such as milling, boring, tapping, and the like.

The spindle may have its axis arranged horizontally or vertically.

It is also known to provide machining centers of the above cited type with a mechanized tool magazine, from which the spindle automatically picks up the tools to be used in the various machining steps by utilizing the mobility in space of the machining head.

A conventional tool magazine, particularly appreciated for its reliability, comprises a motorized tool holding drum. In the case of a spindle with horizontal axis, the tool holding drum can be arranged so as to face the spindle with its horizontal axis and at right angles to the axis of the spindle, so as to present to said spindle the tools to be picked up.

In order to increase productivity, the machining center may be also provided with multiple parallel spindles mounted on a single machining head, so as to machine multiple workpieces simultaneously.

Although machining centers of the above cited type are highly appreciated both for their machining precision and for their productivity—since they are able to perform several machining operations on the workpiece with a single positioning—they have, however, the limitation of being suitable mostly for the machining of small- to medium-sized workpieces, for example mechanical parts in the automotive sector or in the industrial sector.

Larger workpieces, such as portions of the chassis or body of a vehicle, currently can be subjected to successive machining processes on different machine tools, with a consequent drastic reduction in both productivity and machining precision, since the workpiece must be repositioned each time it is transferred from one machine tool to the next.

So-called multitasking machines are known which are capable of performing different machining processes on large workpieces, but they too are limited in terms of productivity since they are provided with a single spindle which can move with respect to multiple axes, for example five axes.

In addition, known multitasking machines, despite using a single spindle, are extremely bulky and therefore difficult to place inside the production facility.

### SUMMARY

The aim of the present disclosure is to provide a multi-axis machining center with mechanized tool magazine that is capable of machining large workpieces, such as portions of the chassis or body of vehicles, while having substantially the same machining versatility and the same dimensions as machining centers intended for machining small- to medium-sized workpieces.

Within this aim, the present disclosure provides a multi-axis machining center that has a much greater productivity than currently known multitasking machines for machining large workpieces.

This aim and this and other advantages which will become better apparent from the description that follows are achieved by providing the machining center having the characteristics described in claim 1, while the dependent claims define other advantageous, albeit secondary, characteristics of the disclosure.

### BRIEF DESCRIPTION OF THE DRAWINGS

The disclosure is now described in greater detail with reference to some of its preferred but not exclusive embodiments, illustrated by way of non-limiting example in the accompanying drawings, wherein:

FIG. 1 is a schematic plan view of a machining center according to the disclosure; and

FIG. 2 is a schematic lateral elevation view of the machining center of FIG. 1.

### DETAILED DESCRIPTION OF THE DRAWINGS

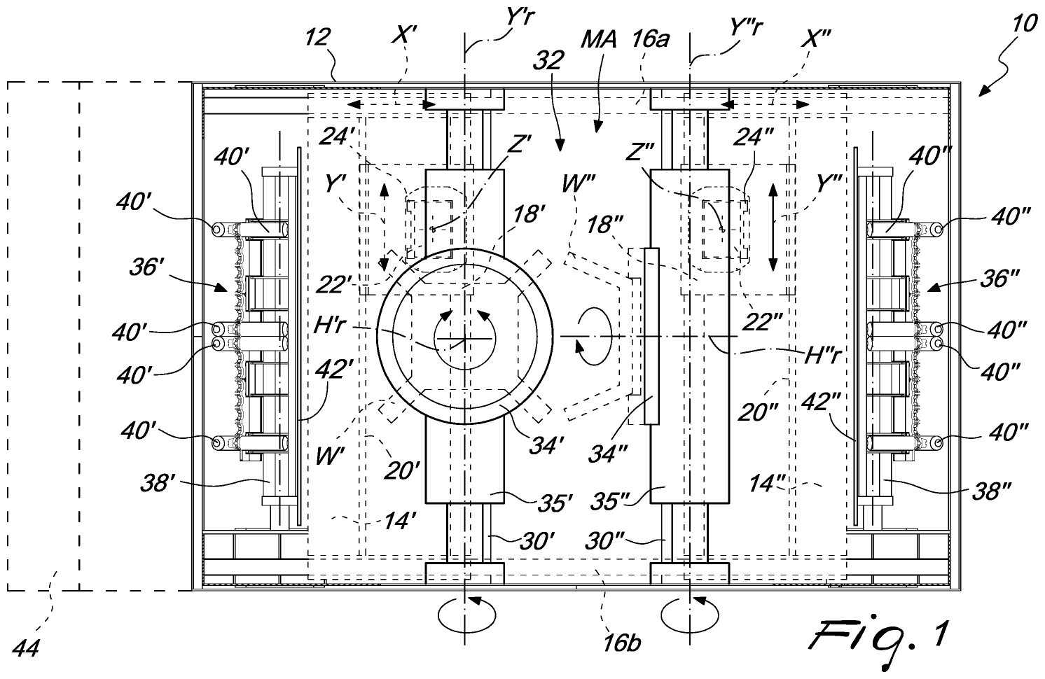

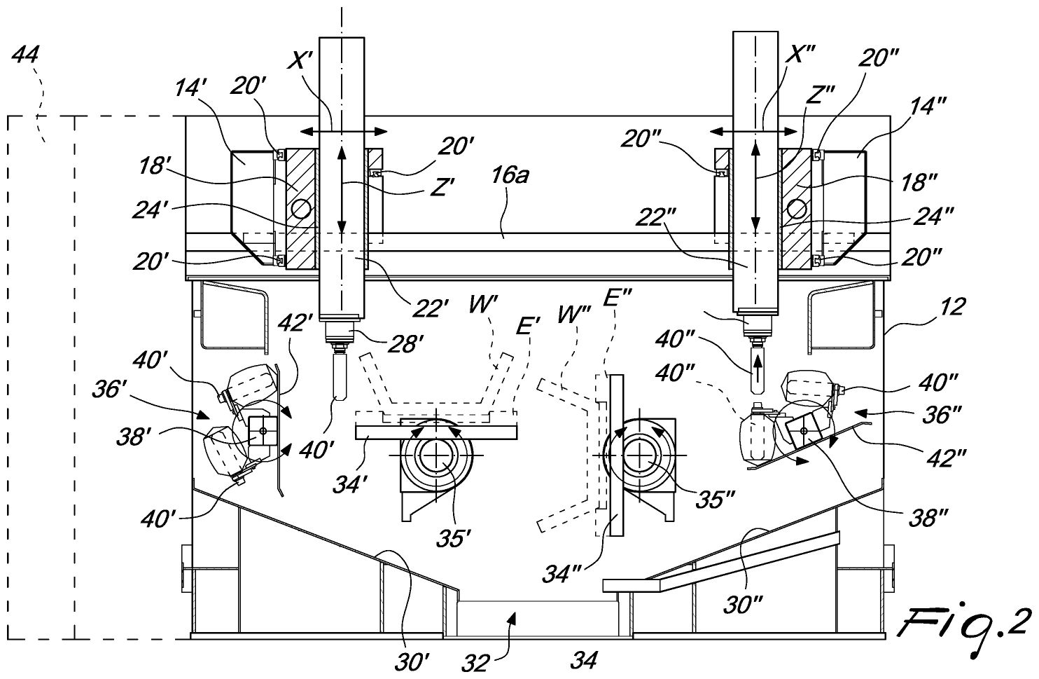

With reference to FIGS. 1 and 2, a machining center 10 according to the disclosure comprises a supporting structure 12, which in the schematic embodiment shown has a box-like profile, in which a work area MA is defined.

Two independent carriages 14′, 14″ are slidingly supported by a pair of parallel horizontal rails 16a, 16b fixed in an elevated position, preferably at the upper end, of the supporting structure 12 and extended in a longitudinal direction.

Therefore, each one of the two carriages 14′, 14″ can slide along a respective longitudinal translation axis X′, X″.

Each one of the two carriages 14′, 14″ supports a respective slider 18′, 18″, which can slide along a respective horizontal guide 20′, 20″ which is integral with the carriage 14′, 14″ and is extended along a respective transverse translation axis Y′, Y″.

Each one of the sliders 18′, 18″ supports a respective machining head 22′, 22″, which is in turn supported slidingly on a respective vertical guide 24′, 24″ which is integral with the slider 18′, 18″ and is extended along a respective vertical translation axis Z′, Z″.

In particular, the machining head 22′, 22″ supports, at its lower end, a spindle 28′, 28″ arranged so that its axis is vertical.

The spindle 28′, 28″ can mount different type of tools for machining processes such as milling, boring, tapping and the like.

According to a preferred embodiment of the disclosure, the supporting structure 12 has a base which comprises at least one chute which leads into a chip discharge area, advantageously two longitudinally mutually opposite chutes 30′, 30″ which lead into a central chip discharge area 32.

The base 30′, 30″ supports at least one workpiece holding table, advantageously two workpiece holding tables 34′, 34″ in mirror longitudinal positions, preferably arranged along the centerline axis of the machining center 10.

Each one of the workpiece holding tables 34′, 34″ is supported by a rotating workpiece holding drum 35′, 35″ the horizontal axis Yr′, Yr″ of which extends in a horizontal and transverse direction. Furthermore, the workpiece holding table 34′, 34″ is supported by the respective workpiece holding drum 35′, 35″ so that it can rotate about an axis of rotation Hr′, Hr″ of its own, which is at right angles to the axis of rotation of the workpiece holding drum 35′, 35″.

In a per se known manner, two workpieces W′, W″ being processed can be fixed to the respective workpiece holding tables 34′, 34″ by means of respective workpiece holding fixtures E′, E″.

The machining center 10 is provided with two mechanized tool magazines 36′, 36″ arranged at the opposite longitudinal ends of the supporting structure 12 so as to be accessible by the two spindles 28′, 28″ respectively.

In this embodiment, each one of the two tool magazines 36′, 36″ comprises a rotating tool holding drum 38′, 38″ which supports peripherally a plurality of tools 40′, 40″. The rotating tool holding drums 38′, 38″ are arranged so that their axes are horizontal and parallel to the transverse translation axes Y′, Y″. In each of the tool magazines 36′, 36″, the tools 40′, 40″ are arranged on two angularly spaced rows of the respective tool holding drum 38′, 38″, said rows extending parallel to the axis of the respective tool holding drum 38′, 38″.

The spindles 28′, 28″ pick up automatically the tools 40′, 40″ to be used in the various machining steps from the respective mechanized tool magazines 36′, 36″, utilizing the mobility in space of the respective machining heads 22′, 22″. Depending on where the tool is arranged on the tool holding drum 38′, 38″, said drum is rotated so as to present the tools of one row or the other to the respective spindle 28′, 28″.

Advantageously, each one of the tool magazines 36′, 36″ is provided with a shield 42′, 42″ which, in this embodiment, is fixed to the respective tool holding drum 38′, 38″. During machining, the tool holding drum 38′, 38″ is rotated so as to direct the respective shield 42′, 42″ toward the work area MA, so as to hide the respective tool magazine 36′, 36″ and protect it from the machining chips.

In an alternative embodiment, the shields might be movable independently of the respective drums.

Of course, all of the above described movable components of the machining center are motorized by means of actuation systems of the conventional type, for example electric actuators, hydraulic actuators and/or pneumatic actuators, which are subjected to a control unit (not shown), in a manner that is per se conventional in the field.

A hydraulic/electric control unit 44 (shown only schematically with the dashed line in the figures) is arranged selectively at one of the two longitudinal ends of the supporting structure 12, in a spaced position so as to form an operator passage for access to the tool magazine.

Naturally, the supporting structure 12 can be provided with inspection doors or windows (not shown) on one or more sides, in a manner that is per se conventional in the field.

In operation, the workpieces W′, W″ are fixed on the respective workpiece holding tables 34′, 34″ by means of the respective fixtures E′, E″.

Since the carriages 14′, 14″ share the same rails 16a, 16b, each one of the workpieces can be machined simultaneously by both spindles 28′, 28″, or the spindles 28′, 28″, being completely independent, can work on respective workpieces, with much greater versatility than known solutions.

During machining, the shields 42′, 42″ protect the tool magazines 36′, 36″ from the machining chip, which therefore falls in the chip collection area 32 by means of the chutes 30′, 30″.

The spindles 28′, 28″ can move along the three Cartesian axes. Two additional degrees of freedom are provided by the rotation of the workpiece holding tables 34′, 34″ about their own axis and about the axis of the respective workpiece holding drum, so that any workpiece, with a single placement, can be machined substantially in any direction and on any side directed toward the work area MA.

As the person skilled in the art may appreciate, one advantage of the disclosure is that the two carriages 14′, 14″ share the same rails 16a, 16b for translation in a longitudinal direction. In this manner, each one of the two spindles 28′, 28″ can “trespass”, in a longitudinal direction, onto the half of the work area that is occupied by the other spindle, thus offering high versatility.

Some preferred embodiments of the disclosure have been described, but the person skilled in the art may of course apply various modifications and variations within the scope of the claims.

For example, each one of the carriages might support two sliders, and each one of the sliders in turn might support two or more spindles for machining simultaneously multiple relatively small workpieces mounted on the workpiece holding tables. In fact, although the machining center described and illustrated herein has been conceived for the machining of large workpieces, such as chassis or body parts in the automotive, aviation, nautical industry and the like, it has been found in practice that the same principles can be applied to machining centers for machining small- to medium-sized workpieces, obtaining numerous advantages.

The guiding means that allow the translation or rotation of the various movable elements of the machining center may be provided by means of technologies commonly used in the industry, which are well known to the person skilled in the art, such as rotating supports or sliding supports using rolling bearings, low-friction sliders, and the like.

Although tool magazines of the type described above are particularly appreciated for their reliability, one or both of the tool magazines might of course be of a different type, for example, chain-based tool magazines.

1-9. (canceled)

10. A machining center comprising: two independent carriages both supported to slide along respective longitudinal translation axes by a pair of parallel horizontal rails which extend along a longitudinal direction and are fixed in a raised position to a supporting structure, each one of said carriages supporting a respective machining head configured to move along a respective transverse translation axis and along a respective vertical translation axis by means of respective guiding means, each one of said machining heads supporting a respective tool holding spindle arranged with a vertical axis, said machining center further comprising at least one workpiece holding table supported at a base of said supporting structure in a rotatable manner about a first rotation axis which extends in a horizontal and transverse direction, and about a second rotation axis, which is perpendicular to the first rotation axis, and two mechanized tool magazines supported at opposite longitudinal ends of said supporting structure in order to be accessible by each one of said spindles.

11. The machining center according to claim 10, further comprising two of said workpiece holding tables in mirror longitudinal positions.

12. The machining center according to claim 10, wherein said at least one workpiece holding table is arranged along a centerline axis of said machining center.

13. The machining center according to claim 10, wherein said guiding means comprise, for each one of said carriages, a slider which slides along a respective horizontal guide which is integral with the carriage and extends in a transverse direction, and, for each one of said sliders, a vertical guide which is integral with the slider and is engaged slidingly by a respective one of the machining heads.
